(19) United States
(12) Patent Application Publication
(10) Pub. No.: US 2022/0382190 A1
(43) Pub. Date: Dec. 1, 2022

(54) FIXING DEVICE AND IMAGE FORMING APPARATUS

(71) Applicant: FUJIFILM Business Innovation Corp., Tokyo (JP)

(72) Inventor: Motoharu NAKAO, Kanagawa (JP)

(73) Assignee: FUJIFILM Business Innovation Corp., Tokyo (JP)

(21) Appl. No.: 17/517,673

(22) Filed: Nov. 3, 2021

(30) Foreign Application Priority Data
May 25, 2021 (JP) 2021-087853

(51) Int. Cl. G03G 15/20

(52) U.S. Cl. CPC G03G 15/2053

(57) ABSTRACT

A fixing device includes a rotatable endless belt; a holding section that is disposed inside the belt and holds a planar heat-generating element so as to bring the belt into pressure contact with a rotating body at a pressure contact portion; and a roughened portion that is provided adjacent to a downstream side in a movement direction of the belt with respect to the pressure contact portion of the holding section and subjected to a roughening treatment for holding abrasion powder on an inner surface of the belt.

### CROSS-REFERENCE TO RELATED APPLICATIONS

This application is based on and claims priority under 35 USC 119 from Japanese Patent Application No. 2021-087853 filed May 25, 2021.

### BACKGROUND

### (i) Technical Field

The present invention relates to a fixing device and an image forming apparatus.

### (ii) Related Art

In the related art, as techniques related to fixing devices, for example, fixing devices disclosed in JP2020-154074A have already been proposed.

JP2020-154074A discloses a configuration in which the surface roughness Ra of an inner surface of a belt is set to 0.3 μm to 1.5 μm in order to facilitate holding a lubricant between the belt and a sliding member (Paragraph) [0043]).

### SUMMARY

Aspects of the non-limiting embodiments of the present disclosure relate to a fixing device and an image forming apparatus that can suppress the occurrence of poor lubrication due to the abrasion powder generated by the wear of an inner surface of a belt brought into pressure contact with a rotating body burying irregularities on the inner surface of the belt.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a fixing device including a rotatable endless belt; a holding section that is disposed inside the belt and holds a planar heat-generating element so as to bring the belt into pressure contact with a rotating body at a pressure contact portion; and a roughened portion that is provided adjacent to a downstream side in a movement direction of the belt with respect to the pressure contact portion of the holding section and subjected to a roughening treatment for holding abrasion powder on an inner surface of the belt.

### BRIEF DESCRIPTION OF THE DRAWINGS

Exemplary embodiment(s) of the present invention will be described in detail based on the following figures, wherein:

FIG. 1 is an overall configuration diagram showing an image forming apparatus to which a fixing device according to Exemplary Embodiment 1 of the present invention is applied;

FIG. 2 is a cross-sectional configuration diagram showing the fixing device according to Exemplary Embodiment 1 of the present invention;

FIG. 3 is a cross-sectional configuration diagram showing a heating belt;

FIG. 4 is a plan configuration diagram showing a heat-generating portion of a ceramic heater;

FIG. 5 is a cross-sectional configuration diagram showing major parts of the fixing device according to Exemplary Embodiment 1 of the present invention;

FIG. 6 is a cross-sectional configuration diagram showing major parts of the fixing device according to Exemplary Embodiment 1 of the present invention;

FIG. 7 is an enlarged cross-sectional diagram showing a nip portion of the fixing device according to Exemplary Embodiment 1 of the present invention;

FIG. 8 is a graph showing a relationship between the number of bearing characteristics and the coefficient of dynamic friction;

FIG. 9 is a cross-sectional schematic diagram showing major parts of the fixing device according to Exemplary Embodiment 1 of the present invention;

FIGS. 10A to 10D are explanatory diagrams showing a transition state from fluid lubrication to mixed lubrication;

FIG. 11 is a schematic view showing the worn state of an inner surface of a heating belt;

FIG. 12 is a cross-sectional schematic diagram showing major parts of the fixing device according to Exemplary Embodiment 1 of the present invention; and

FIG. 13 is a cross-sectional schematic diagram showing the operation of the fixing device according to Exemplary Embodiment 1 of the present invention.

### DETAILED DESCRIPTION

Hereinafter, an exemplary embodiment of the present invention will be described with reference to the drawings.

### Exemplary Embodiment 1

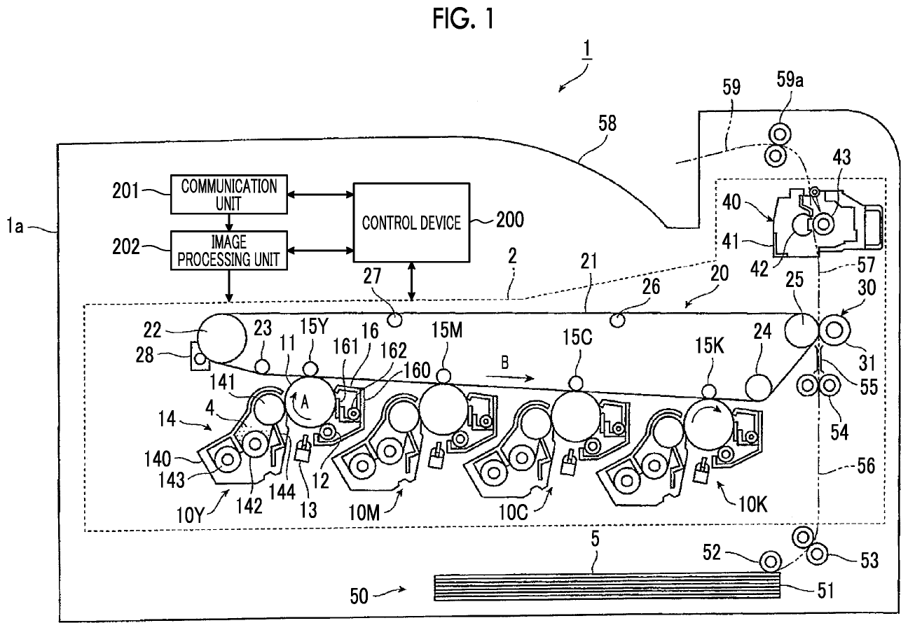

FIG. 1 shows an image forming apparatus to which a fixing device according to Exemplary Embodiment 1 is applied.

Overall Configuration of Image Forming Apparatus

The image forming apparatus 1 according to Exemplary Embodiment 1 is configured as, for example, a color printer. The image forming apparatus 1 includes a plurality of image creating devices 10 that form toner images developed with a toner constituting a developer 4, an intermediate transfer device 20 that holds a toner image formed by each image creating device 10 and finally transports the held toner image to a secondary transfer position where the transported toner image is secondarily transferred to recording paper 5 serving as an example of a recording medium, a paper feed device 50 that accommodates and transports a required recording paper 5 to be supplied to the secondary transfer position of the intermediate transfer device 20, and a fixing device 40 that fixes the toner image on the recording paper 5 secondarily transferred by the intermediate transfer device 20. The plurality of image creating devices 10 and the intermediate transfer device 20 constitute an image forming section 2 that forms an image on the recording paper 5. In addition, 1a in the figure indicates an apparatus body of the image forming apparatus 1, and the apparatus body 1a is formed of a supporting structural member, an exterior cover, and the like. Additionally, a two-dot chain line in the figure indicates a transport route along which the recording paper 5 is transported in the apparatus body 1a.

The image creating device 10 includes four image creating devices 10Y, 10M, 10C, and 10K that exclusively form toner images in four colors of yellow (Y), magenta (M), cyan (C), and black (K), respectively. The four image creating devices 10 (Y, M, C, K) are disposed to be arranged in a row in an inclined state in an internal space of the apparatus body 1a.

The four image creating devices 10 include yellow (Y), magenta (M), and cyan (C) color image creating devices 10 (Y, M, C) and a black (K) image creating device 10K. The black image creating device 10K is disposed on the most downstream side along a movement direction B of the intermediate transfer belt 21 of the intermediate transfer device 20. The image forming apparatus 1 includes, as image forming modes, a full-color mode in which the color image creating devices 10 (Y, M, C) and the black (K) image creating device 10K are operated to form a full-color image, and a black-and-white mode in which only the black (K) image creating device 10K is operated to form a black-and-white (monochrome) image.

As shown in FIG. 1, each of the image creating devices 10 (Y, M, C, K) includes a rotating photoconductive drum 11 serving as an example of an image holder, and each device serving as an example of the following toner image forming section is disposed around the photoconductive drum 11. The devices are a charging device 12 that charges a peripheral surface (image holding surface) capable of forming an image on each photoconductive drum 11 to a required potential, an exposure device 13 that irradiates the charged peripheral surface of the photoconductive drum 11 with the light based on information (signal) of an image to form an electrostatic latent image (for each color) having a potential difference, a developing device 14 (Y, M, C, K) that develop the electrostatic latent image with a toner of a developer 4 for a corresponding color (Y, M, C, K) to form a toner image, a primary transfer device 15 (Y, M, C, K) that transfer each toner image to the intermediate transfer device 20, and a drum cleaning device 16 (Y, M, C, K) that remove and clean a deposit such as the toner remaining on and adhering to the image holding surface of the photoconductive drum 11 after the primary transfer.

The photoconductive drum 11 has an image holding surface having a photoconductive layer (photosensitive layer) made of a photosensitive material formed on a peripheral surface of a cylindrical or columnar base material to be subjected to ground treatment. The photoconductive drum 11 is supported such that power is transmitted thereto from a drive device (not shown) and the photoconductive drum 11 rotates in a direction indicated by arrow A.

The charging device 12 includes a contact type charging roll that is disposed in contact with the photoconductive drum 11. A charging voltage is supplied to the charging device 12. As the charging voltage, in a case where the developing device 14 performs reverse development, a voltage or current having the same polarity as the charging polarity of the toner supplied from the developing device 14 is supplied. In addition, as the charging device 12, a non-contact type charging device such as a scorotron disposed on the surface of the photoconductive drum 11 in a non-contact state may be used.

The exposure device 13 consists of an LED printhead that irradiates the photoconductive drum 11 with the light according to the image information by a plurality of light emitting diodes (LEDs) serving as a plurality of light emitting elements arranged in an axial direction of the photoconductive drum 11 to form an electrostatic latent image. In addition, as the exposure device 13, one that deflects and scans a laser beam configured in accordance with the image information in the axial direction of the photoconductive drum 11 may be used.

All of the developing devices 14 (Y, M, C, K) are configured such that a developing roll 141 that holds the developer 4 to transport the developer 4 to a developing region that faces the photoconductive drum 11, agitating and transporting members 142 and 143 such as two screw augers that transports the developer 4 to pass through the developing roll 141 while agitating the developer 4, a layer thickness regulating member 144 that regulates the amount (layer thickness) of the developer held on the developing roll 141, and the like are disposed inside a housing 140 in which an opening portion and an accommodation chamber of the developer 4 are formed. A developing voltage is supplied to the developing device 14 from a power supply device (not shown) between the developing roll 141 and the photoconductive drum 11. Additionally, the developing roll 141 and the agitating and transporting members 142 and 143 rotate in a required direction by transmitting power from the drive device (not shown). Moreover, as the four-color developers 4 (Y, M, C, K), two-component developers containing a non-magnetic toner and a magnetic carrier are used.

The primary transfer device 15 (Y, M, C, K) is a contact type transfer device including a primary transfer roll that rotates around the photoconductive drum 11 in contact therewith via the intermediate transfer belt 21 and is supplied with a primary transfer voltage. As the primary transfer voltage, a direct-current voltage indicating a polarity opposite to the charging polarity of the toner is supplied from the power supply device (not shown).

The drum cleaning device 16 includes a container-shaped body 160 that partially opens, a cleaning plate 161 that is disposed to be in contact with the peripheral surface of the photoconductive drum 11 after the primary transfer at a required pressure and removes and cleans deposits such as residual toner, a delivery member 162 such as a screw auger that recovers the deposits such as toner removed by the cleaning plate 161 and transports the deposits for delivery to a recovery system (not shown), and the like. As the cleaning plate 161, a plate-shaped member (for example, a blade) made of a material such as rubber is used.

As shown in FIG. 1, the intermediate transfer device 20 is disposed to be present at a position above each image creating device 10 (Y, M, C, K). The intermediate transfer device 20 includes an intermediate transfer belt 21 that rotates in a direction indicated by arrow B while passing through a primary transfer position between the photoconductive drum 11 and the primary transfer device 15 (primary transfer roll), a plurality of belt support rolls 22 to 27 that hold the intermediate transfer belt 21 in a desired state from an inner surface thereof and rotatably support the intermediate transfer belt 21, a secondary transfer device 30 serving as an example of a secondary transfer section that is disposed on an outer peripheral surface (image holding surface) side of the intermediate transfer belt 21 supported by the belt support roll 25 and secondarily transfers an toner image on the intermediate transfer belt 21 to the recording paper 5, and a belt cleaning device 28 that removes and cleans deposits such as toner and paper dust remaining on and adhering to the outer peripheral surface of the intermediate transfer belt 21 after passing through the secondary transfer device 30.

As the intermediate transfer belt 21, for example, an endless belt made of a material in which a resistance modifier such as carbon black is dispersed in a synthetic resin such as a polyimide resin or a polyamide resin is used. Additionally, the belt support roll 22 is configured as a drive roll that is rotationally driven by the drive device (not shown) that also serves as a counter roll of the belt cleaning device 28, the belt support roll 23 is configured as a face-out roll that forms an image forming surface of the intermediate transfer belt 21, the belt support roll 24 is configured as a tension applying roll that applies tension to the intermediate transfer belt 21, the belt support roll 25 is configured as a counter roll that faces the secondary transfer device 30, and the belt support rolls 26 and 27 are configured as driven rolls that support the traveling position of the intermediate transfer belt 21.

As shown in FIG. 1, the secondary transfer device 30 is a contact type transfer device including a secondary transfer roll 31, which rotates in contact with a peripheral surface of the intermediate transfer belt 21 and is supplied with a secondary transfer voltage, at the secondary transfer position that is an outer peripheral surface portion of the intermediate transfer belt 21 supported by the belt support roll 25 in the intermediate transfer device 20. Additionally, a direct-current voltage showing the opposite polarity or the same polarity as the charging polarity of the toner is supplied to the secondary transfer roll 31 or the belt support roll 25 of the intermediate transfer device 20 from the power supply device (not shown) as the secondary transfer voltage.

The fixing device 40 is configured such that a heating belt 42 that is rotated in a direction indicated by an arrow and heated by a heating section such that the surface temperature is maintained at a predetermined temperature, a pressure roll 43 or the like that is in contact with the heating belt 42 at a predetermined pressure and rotates in a driven manner substantially in an axial direction of the heating belt 42, and the like are disposed inside the housing 41 in which an introduction port and an ejection port of the recording paper 5 are formed. In the fixing device 40, a contact portion where the heating belt 42 and the pressure roll 43 are in contact with each other is a fixing treatment portion that performs a required fixing treatment (heating and pressurizing). In addition, the fixing device 40 will be described in detail below.

The paper feed device 50 is disposed to be present at a position below the image creating device 10 (Y, M, C, K). The paper feed device 50 includes a single (or a plurality of) paper accommodation body 51 that accommodates the recording paper 5 of a desired size, type, or the like in a loaded state, and delivery devices 52 and 53 that deliver recording paper 5 sheet by sheet from the paper accommodation body 51. The paper accommodation body 51 is attached so that the paper accommodation body 51 can be pulled out to a front side (a side surface facing a user during operation) of the apparatus body 1a, for example.

Examples of the recording paper 5 include thin paper such as plain paper and tracing paper, OHP sheets, or the like, which are used in electrophotographic copying machines and printers. In order to further improve the smoothness of an image surface after fixing, for example, it is preferable that the surface of the recording paper 5 is as smooth as possible. For example, coated paper in which the surface of plain paper is coated with resin or the like, for example, so-called thick paper such as art paper for printing, or the like having a relatively large basis weight can also be used.

A paper feed transport route 56 including a single or a plurality of paper transport roll pairs 54 and transport guides 55, which transport the recording paper 5 delivered from the paper feed device 50 to the secondary transfer position, is provided between the paper feed device 50 and the secondary transfer device 30. The paper transport roll pair 54 disposed at a position immediately before the secondary transfer position in the paper feed transport route 56 is configured as, for example, a roll (registration roll) that adjusts the transport timing of the recording paper 5. Additionally, a paper transport route 57 for transporting the recording paper 5 after the secondary transfer, which is delivered from the secondary transfer device 30, to the fixing device 40 is provided between the secondary transfer device 30 and the fixing device 40. Moreover, an ejection transport route 59 including a paper ejection roll pair 59a for ejecting the recording paper 5 after the fixing, which is delivered from the fixing device 40 by an outlet roll 36, to a paper ejection portion 58 on an upper portion of the apparatus body 1a is provided in a portion of the image forming apparatus 1 near the paper ejection port formed in the apparatus body 1a.

Reference sign 1200 in FIG. 1 indicates a control device that comprehensively controls the operation of the image forming apparatus 1. The control device 200 includes a central processing unit (CPU), a read only memory (ROM), a random access memory (RAM) (not shown), a bus for connecting the CPU, the ROM, and the like to each other, a communication interface, and the like. Additionally, reference sign 201 indicates a communication unit in which the image forming apparatus 1 communicates with an external device, and reference sign 202 indicates an image processing unit that processes image information input via the communication unit 201.

Operation of Image Forming Apparatus

Hereinafter, the basic image forming operation by the image forming apparatus 1 will be described.

Here, first, the operation in the full-color mode in which a full-color image configured by combining toner images of four colors (Y, M, C, K) is formed using the four image creating devices 10 (Y, M, C, K) will be is described.

In a case where the image forming apparatus 1 receives image information and request command information for a full-color image forming operation (print) from a personal computer, an image reading device, or the like (not shown) via the communication unit 201, the control device 200 starts the four image creating devices 10 (Y, M, C, K), the intermediate transfer device 20, the secondary transfer device 30, the fixing device 40, and the like.

Then, in each image creating device 10 (Y, M, C, K), as shown in FIG. 1, each photoconductive drum 11 first rotates in the direction indicated by the arrow A, and each charging device 12 charges the surface of the photoconductive drum 11 to a required polarity (negative polarity in Exemplary Embodiment 1) and a required potential. Subsequently, the exposure device 13 irradiates the surface of the photoconductive drum 11 after charging with the light emitted on the basis of image signals obtained by converting the image information input to the image forming apparatus into each color component (Y, M, C, K) by the image processing unit 202, and forms an electrostatic latent image of each color component configured with a required potential difference on the surface thereof.

Subsequently, each image creating device 10 (Y, M, C, K) supplies a toner of a corresponding color (Y, M, C, K) charged with a required polarity (negative polarity) from the developing rolls 141 to the electrostatic latent image of each color component formed on the photoconductive drum 11 and causes the toner to electrostatically adhere to the electrostatic latent image to development. By virtue of this development, the electrostatic latent images of the respective color components formed on the respective photoconductive drums 11 are visualized as toner images of four colors (Y, M, C, K) developed with the toners of the corresponding colors.

Subsequently, in a case where the toner image of each color formed on the photoconductive drum 11 of each image creating device 10 (Y, M, C, K) is transported to the primary transfer position, the primary transfer device 15 (Y, M, C, K) primarily transfers the toner image of each color in a state in which the toner image of each color is sequentially superimposed on the intermediate transfer belt 21 while rotating in the direction indicated by the arrow B of the intermediate transfer device 20.

Additionally, in each image creating device 10 (Y, M, C, K) in which the primary transfer is completed, the drum cleaning device 16 removes deposits to scrape off the deposits and cleans the surface of the photoconductive drum 11. Accordingly, each image creating device 10 (Y, M, C, K) is in a state in which the next image creating operation can be performed.

Subsequently, the intermediate transfer device 20 holds the toner image that is primarily transferred by the rotation of the intermediate transfer belt 21 and transports the toner image to the secondary transfer position. Meanwhile, in the paper feed device 50, the required recording paper 5 is delivered to the paper feed transport route 56 in conformity with the image creating operation. In the paper feed transport route 56, the paper transport roll pair 54 serving as the registration roll delivers and supplies the recording paper 5 to the secondary transfer position in conformity with a transfer timing.

At the secondary transfer position, the secondary transfer device 30 collectively secondarily transfers the toner image on the intermediate transfer belt 21 to the recording paper 5. Additionally, in the intermediate transfer device 20 in which the secondary transfer is completed, the belt cleaning device 28 removes and cleans the deposits such as toner remaining on the surface of the intermediate transfer belt 21 after the secondary transfer.

Subsequently, the recording paper 5 on which the toner image is secondarily transferred is peeled off from the intermediate transfer belt 21 and then transported to the fixing device 40 via the paper transport route 57. In the fixing device 40, by introducing and passing the recording paper 5 after the secondary transfer into and through the contact portion between the rotating heating belt 42 and the pressure roll 43, the required fixing treatment (heating and pressurizing) is performed, and an unfixed toner image is fixed on the recording paper 5. Finally, the recording paper 5 after the fixing is completed is ejected to, for example, the paper ejection portion 58 installed in the upper portion of the apparatus body 1a by the paper ejection roll pair 59a.

By the above operation, the recording paper 5 on which the full-color image configured by combining the toner images of four colors is formed is output.

Configuration of Fixing Device

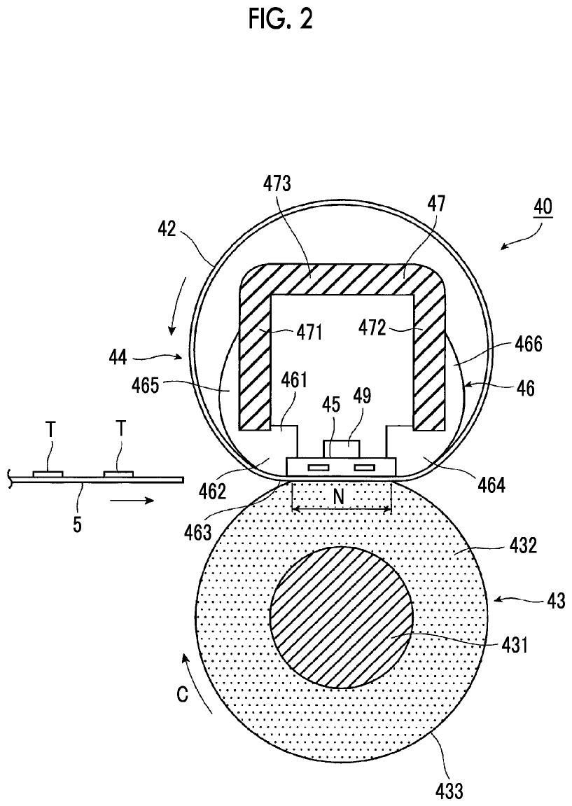

FIG. 2 is a cross-sectional configuration diagram showing the fixing device according to Exemplary Embodiment 1.

As shown in FIG. 2, the fixing device 40 generally includes a heating unit 44 having the heating belt 42 serving as an example of a rotating endless belt, and the pressure roll 43 serving as an example of a rotating body being in pressure contact with the heating unit 44. A fixing nip portion N serving as an example of a pressure contact portion, which is a region through which the recording paper 5 serving as an example of a recording medium holding an unfixed toner image T serving as an example of an unfixed image passes, is formed between the heating belt 42 and the pressure roll 43. In addition, the recording paper 5 is transported with a center in a direction intersecting a transport direction as a reference (so-called center registration). As shown in FIG. 1, the fixing device 40 is disposed such that the heating belt 42 and the pressure roll 43 face each other in a substantially horizontal direction in order to perform the fixing treatment on the recording paper 5 transported in an extension direction, in the paper transport route 57 along which the recording paper 5 is transported from a lower side toward an upper side in a vertical direction. However, in FIG. 2, for convenience, the heating belt 42 and the pressure roll 43 are shown in an upward-downward direction.

As shown in FIG. 2, the heating unit 44 includes the heating belt 42, a ceramic heater 45 serving as an example of a planar heat-generating section (planar heat-generating element) that is disposed inside the heating belt 42 and heats the heating belt 42, a holding member 46 serving as an example of a holding section that is also disposed inside the heating belt 42 and holds the ceramic heater 45 to be in pressure contact with the surface of the pressure roll 43 via the heating belt 42, a support member 47 serving as an example of a support section that is disposed inside the heating belt 42 and supports the holding member 46 to be in pressure contact with the pressure roll 43.

In addition, in the ceramic heater 45 serving as an example of the planar heat-generating section, a heat-generating portion itself is not necessarily planar. Even in a case where the heat-generating portion may be linearly formed, a lower end surface (heating surface) of the ceramic heater 45 that heats the heating belt 42 may be planar. Additionally, the lower end surface (heating surface) of the ceramic heater 45 is not necessarily a flat surface and may have a curved surface shape.

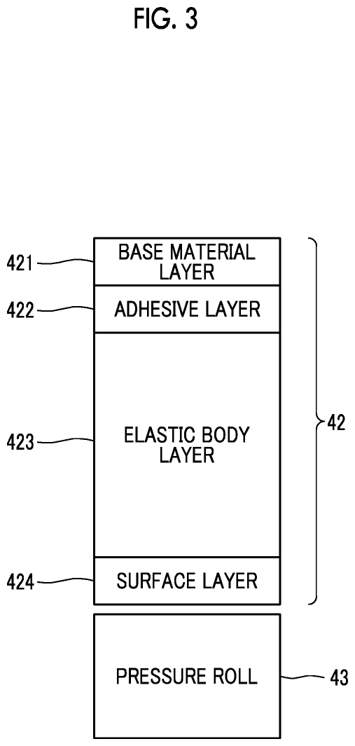

The heating belt 42 is made of a material having flexibility and is configured as an endless belt in which a free shape thereof is thin-walled cylindrical in a state before mounting. As shown in FIG. 3, the heating belt 42 has a base material layer 421 that is disposed on the ceramic heater 45 side, an elastic body layer 423 that is coated on the surface of the base material layer 421 via an adhesive layer 422, and a surface layer 424 that is coated on the surface of the elastic body layer 423 directly or via an adhesive layer (not shown). The heating belt 42 does not necessarily include all of the base material layer 421, the adhesive layer 422, the elastic body layer 423, and a release layer 433, and may include the base material layer 421, the surface layer 424, and the like. The base material layer 421 is formed using a heat-resistant synthetic resin such as polyimide, polyamide, or polyimideamide as a component. The elastic body layer 423 is made of a heat-resistant elastic body such as silicone rubber or fluororubber. The surface layer 424 is formed of perfluoroalkoxyalkane (PFA), polytetrafluoroethylene (PTFE), or the like. The thickness of the heating belt 42 can be set to, for example, about 50 μm to 200 μm.

The base material layer 421 contains, as necessary, a heat-resistant synthetic resin such as polyimide, polyamide, or polyimideamide as a component, and a filler such as carbon nanotubes, carbon fibers, or glass fibers is blended to improve the characteristics such as the thermal conductivity of the heating belt 42. For example, as the filler, the carbon nanotubes are desirable from the viewpoint of high thermal conductivity, low coefficient of dynamic friction, and wear resistance.

A back surface (inner surface) of the heating belt 42 includes the base material layer 421. As described above, the base material layer 421 of the heating belt 42 is prepared by blending a heat-resistant synthetic resin such as polyimide, polyamide, or polyimideamide with a filler such as carbon nanotubes, carbon fibers, or glass fibers. The back surface of the heating belt 42 has a required surface roughness Ra. The surface roughness Ra of the back surface of the heating belt 42 is, for example, about 0.3 to 1.5 μm. In addition, the surface roughness Ra conforms to JIS B 0601.

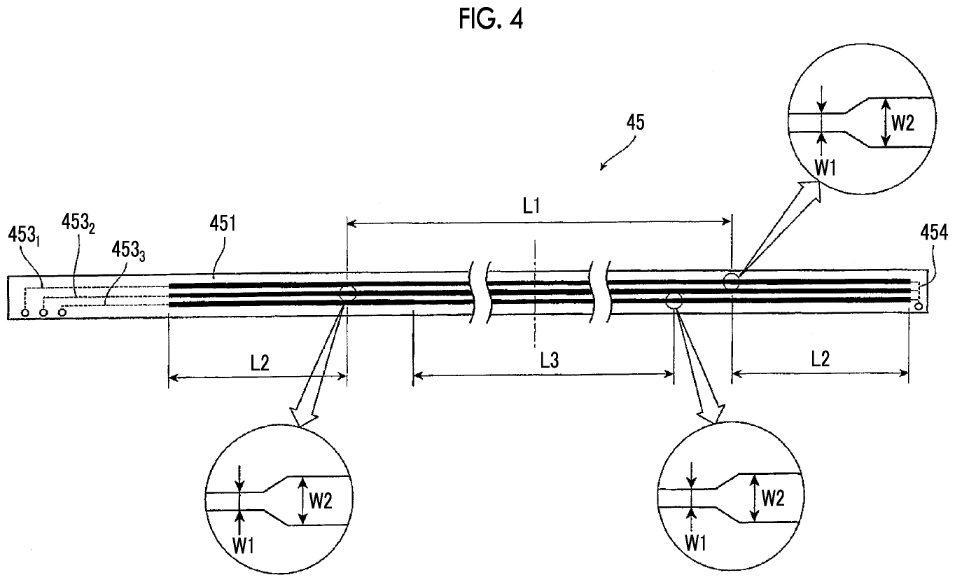

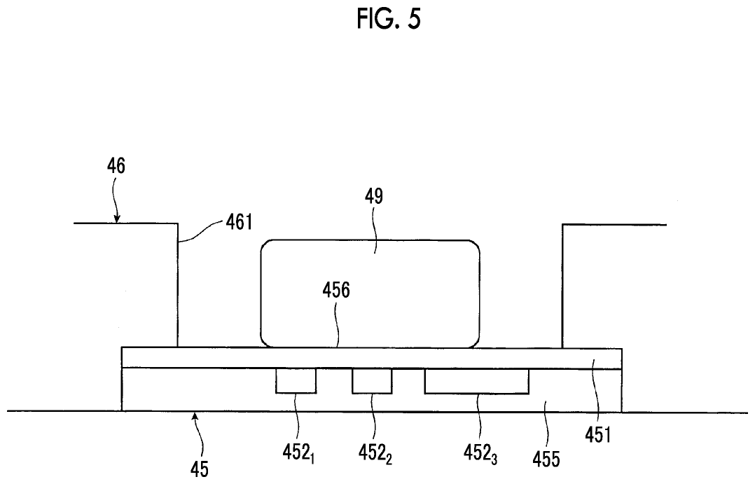

As shown in FIGS. 4 and 5, the ceramic heater 45 includes a ceramic substrate 451, a plurality of first to third heat-generating portions 452₁ to 452₃ linearly formed in the longitudinal direction on the surface of the substrate 451, first to third electrodes 453₁ to 453₃ for individually energizing the first to third heat-generating portions 452₁ to 452₃, a common electrode 454 that commonly energizes the other end portions of the first to third heat-generating portions 452₁ to 452₃, and a coating layer 455 made of glass or the like that is coated on the surfaces of at least the first to third heat-generating portions 452₁ to 452₃.

As shown in FIG. 2, the holding member 46 is made of, for example, a heat-resistant synthetic resin integrally molded into a required shape by injection molding or the like. Examples of the heat-resistant synthetic resin include liquid crystal polymer (LCP), polyetheretherketone (PEEK), polyphenylene sulfide (PPS), polyethersulfone (PES), polyamideimide (PAI), polytetrafluoroethylene (PTFE), polychlorotrifluoroethylene (PCTFE), polyvinylidene fluoride (PVDF), or a composite material thereof.

The holding member 46 has a support frame portion 461 that supports the ceramic heater 45 to pressurize the pressure roll 43 via the heating belt 42 at the fixing nip portion N and is made of an elongated rectangular frame corresponding to the planar shape of the ceramic heater 45 (refer to FIG. 5). The holding member 46 is disposed to be longer than the total length in the longitudinal direction of the heating belt 42.

As shown in FIG. 2, the holding member 46 is provided with a first guide portion 462 that is formed in a curved cross-sectional shape and guides the heating belt 42 to the fixing nip portion N on the upstream side of the fixing nip portion N in a rotational direction of the heating belt 42. A lower end surface 463 of the holding member 46 is formed in a planar shape. The lower end surface 463 of the holding member 46 is formed to form substantially the same plane as the surface of the ceramic heater 45. Additionally, the holding member 46 has a second guide portion 464 provided at a position adjacent to the downstream side of the fixing nip portion N in the rotational direction of the heating belt 42. The second guide portion 464 guides the heating belt 42 to be in contact with the inner surface of the heating belt 42 that has passed through the fixing nip portion N and return to a substantially free shape, and has a cross-sectional shape formed in a curved cross-sectional shape.

Additionally, abutment portions 465 and 466 that hold the support member 47 in a state where the tips of vertical plate portions 471 and 472 of the support member 47 abut against the surface of the holding member 46 opposite to the fixing nip portion N, are provided on the upstream side and the downstream side in the rotational direction of the heating belt 42.

As shown in FIG. 2, the support member 47 is made of, for example, a metallic plate material such as stainless steel, aluminum, or steel. The support member 47 is formed in a substantially U-shaped cross-section from vertical plate portions 471 and 472 that are disposed substantially perpendicular to the surface of the ceramic heater 45 on the upstream side and the downstream side of the fixing nip portion N in the rotational direction of the heating belt 42, and horizontal plate portions 473 that is disposed in the horizontal direction to connect the base end portions of the vertical plate portions 471 and 472.

As shown in FIG. 5, the temperature of the fixing nip portion N of the heating belt 42 is detected by a temperature sensor 49 that is disposed to be in contact with the surface of the ceramic heater 45 opposite to the fixing nip portion N. As described above, the ceramic heater 45 includes the first to third heat-generating portions 452₁ to 452₃ having different heat-generating regions in the longitudinal direction. For that reason, a plurality (for example, three) of temperature sensors 49 are disposed in the longitudinal direction of the ceramic heater 45 in correspondence with the first to third heat-generating portions 452₁ to 452₃. The heating belt 42 is heated such that the fixing nip portion N reaches a required fixing temperature (for example, about 200° C.) depending on the size of the recording paper 5 by controlling the energization of the first to third heat-generating portions 452₁ to 452₃ of the ceramic heater 45 on the basis of the detection result of the temperature sensor 49 by a temperature control circuit (not shown).

As shown in FIG. 2, the pressure roll 43 has a columnar or cylindrical core metal 431 made of metal such as stainless steel, aluminum, or iron (thin-walled high-tension steel pipe), an elastic body layer 432 made of a heat-resistant elastic body such as silicone rubber or fluororubber relatively thickly coated at an outer periphery of the core metal 431, and a release layer 433 made of polytetrafluoroethylene (PTFE), perfluoroalkoxyalkane (PFA), or the like relatively thinly coated on the surface of the elastic body layer 432. In addition, as necessary, a heating section (heating source) including a halogen lamp or the like may be disposed inside the pressure roll 43.

Both end portions of the core metal 431 in the longitudinal direction (axial direction) of the pressure roll 43 are rotatably supported by a frame of a device housing (not shown) of the fixing device 40 via a bearing member. The pressure roll 43 is in pressure contact with the heating unit 44 at a required pressure. The pressure roll 43 is rotationally driven at a required speed in a direction of arrow C by the drive device via a drive gear (not shown) attached to one end portion in an axial direction of the core metal 431 that also serves as a rotation shaft. In addition, the heating belt 42 is in pressure contact against the rotationally driven pressure roll 43 and rotates in a driven manner.

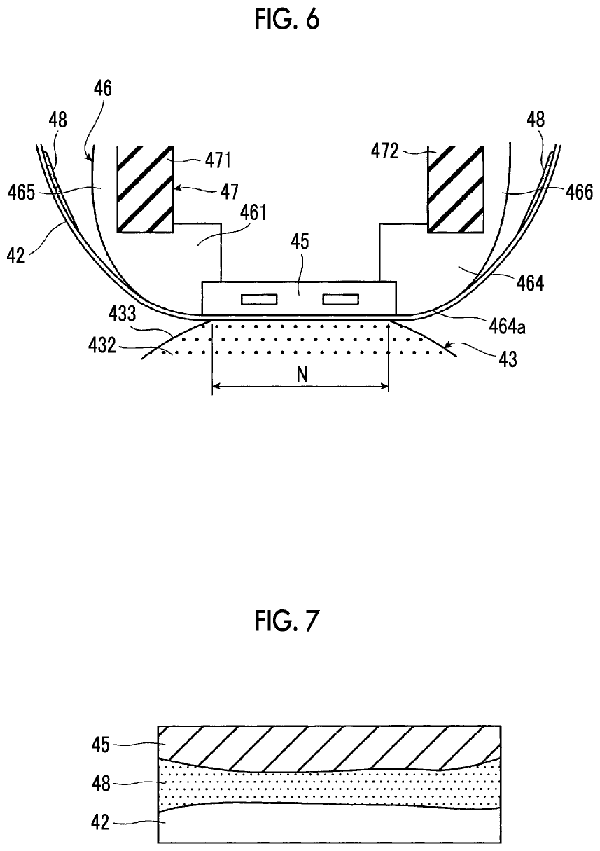

As shown in FIG. 6, in the fixing device 40 configured as described above, the ceramic heater 45 is in pressure contact with the pressure roll 43 via the heating belt 42, and the heating belt 42 rotates in the counterclockwise direction in the figure with the rotation of the pressure roll 43. A lubricant 48 such as silicone oil or grease is applied to an inner peripheral surface of the heating belt in order to reduce the sliding resistance with the ceramic heater 45. The lubricant 48 is supplied in a state of being applied to the inner peripheral surface of the heating belt 42 in advance. Additionally, the lubricant 48 may be configured to be supplied by a lubricant supply member (not shown) made of felt or the like that holds the lubricant 48 and is disposed to be in contact with the inner peripheral surface of the heating belt 42.

Here, in a case where the fixing nip portion N in which the heating belt 42 and the ceramic heater 45 are in pressure contact with each other is microscopically viewed, as schematically shown in FIG. 7, a bearing structure can be provided in which the heating belt 42 is moved in pressure contact with the surface of the fixedly disposed ceramic heater 45 with a required pressing force via a film of the lubricant 48.

In this way, a technical field referred to as tribology has been known as a technical field for studying an interaction such as a case where a relative movement is performed such that two objects consisting of the ceramic heater 45 and the heating belt 42 slide against each other via the film of the lubricant 48.

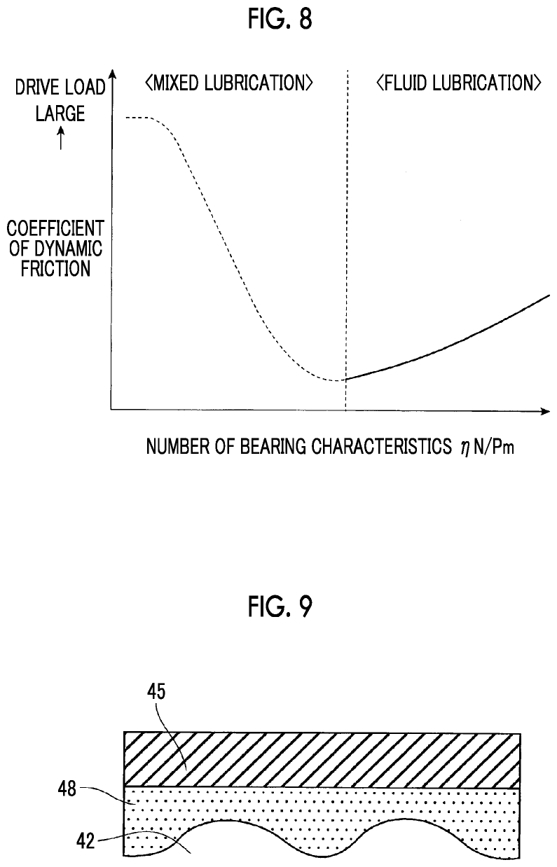

In the tribology, a curve referred to as a Stribeck curve is used to explain the lubrication state between two surfaces that move relative to each other. The Stribeck curve is obtained by measuring the coefficient of friction as a function of load, sliding speed, and temperature (appearing as a change in the viscosity of the lubricant) with respect to the friction of sliding and rolling bearings, and deriving a relationship as shown in FIG. 8. The horizontal axis represents the value of the number of bearing characteristics obtained by η·N/Pm in a case where a pressure contact load acting on two objects is Pm, the relative speed of the two objects is N, and the viscosity of the lubricant is η, and the vertical axis represents a coefficient of dynamic friction.

As shown in FIG. 8, in the region of fluid lubrication in which a layer of lubricant 48 is present between two objects, in a case where sufficient lubricant 48 is initially supplied and the film thickness is large, the coefficient of dynamic friction tends to increase due to an increase in shearing force resulting from the viscosity (molecules on the horizontal axis) of the lubricant 48, or the like. Additionally, in the region of mixed lubrication located between boundary lubrication and fluid lubrication in which the two objects are in direct contact with each other, in a case where the number of bearing characteristics (η·N/Pm) decreases due to a decrease in the film thickness of the lubricant 48, the coefficient of friction increases sharply and shifts to the boundary lubrication showing a substantially constant value. The coefficient of dynamic friction is the lowest in a boundary region between the fluid lubrication and the mixed lubrication.

The conditional expression of the fluid lubrication derived from the Reynolds equation is as follows.

√(ηUKw/P)≥3√(R₁²+R₂²)

Here, the preceding term shows the film thickness of the lubricant, and the latter term shows the roughness of the sliding portion. The roughness of the sliding portion is determined by a surface roughness R₁ of an inner surface of the heating belt 42 and a surface roughness R₂ of the ceramic heater 45.

In Exemplary embodiment 1, in a case where R₃=√/(R₁²+R₂²), 0.7 μm R₃ 0.1 μm is set. In a case where R₃ is less than 0.1 μm, the drive torque at the time of starting becomes excessive, and there is a concern that poor rotation of the heating belt 42 occurs. Additionally, in a case where R3 exceeds 0.7 μm, there is a concern that a stick-slip phenomenon occurs and an abnormal noise is generated.

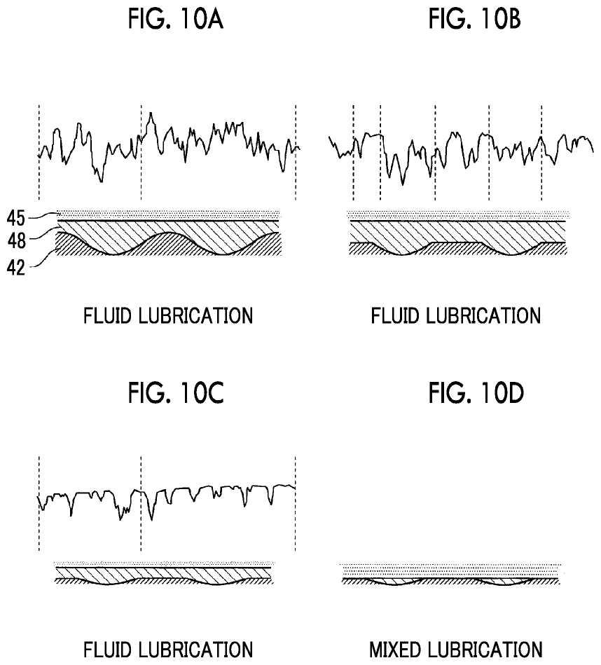

As schematically shown in FIG. 7, the fixing device 40 can be regarded as a fluid-lubricated sliding bearing in which the heating belt 42 is in pressure contact with the surface of the ceramic heater 45 via the film of the lubricant 48. Meanwhile, as shown in FIG. 9, the inner surface of the heating belt 42 is not a flat surface and has a required surface roughness Ra. For that reason, in a case where the fixing device 40 is continuously used, convex portions 42a in the irregularities on the inner surface of the heating belt 42 come into contact with the surface of the ceramic heater 45 and are partially worn. Then, in the fixing device 40, as shown in FIG. 10B, the average film thickness of the lubricant 48 increases, a shearing force resulting from the viscosity of the lubricant or the like increases, the coefficient of dynamic friction increases, and the slope of the Stribeck curve increases in a positive direction.

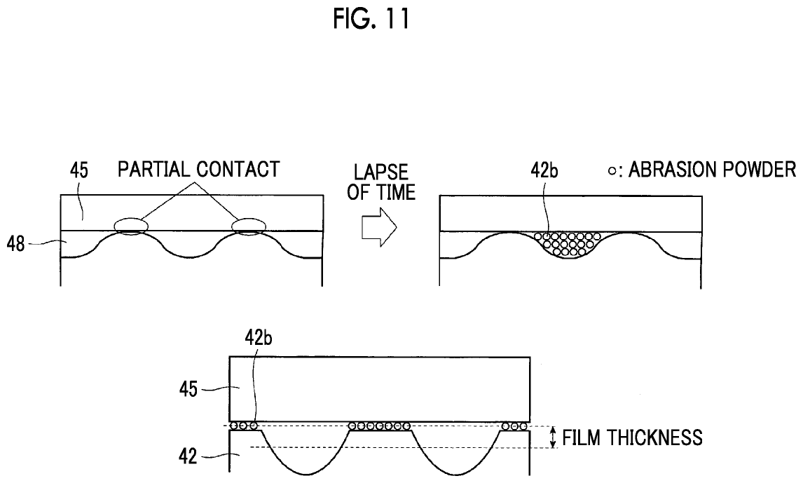

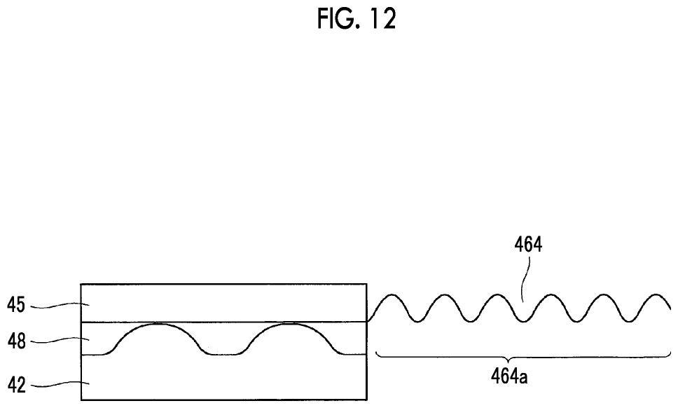

Thereafter, in a case where the fixing device 40 is continuously used, as shown in FIG. 11, abrasion powder 42b generated by the wear of the convex portions on the inner surface of the heating belt 42 deposits on concave portions on the inner surface of the heating belt 42. In a case where the abrasion powder 42b deposits on the concave portions of the inner surface of the heating belt 42, the lubricant 48 applied to the inner surface of the heating belt 42 is adsorbed and held in the concave portion of the heating belt 42 by the capillary phenomenon of the abrasion powder 42b composed of fine particles. The lubricant 48 adsorbed and held in the concave portions of the heating belt 42 does not contribute to the lubrication between the ceramic heater 45 and the heating belt 42.

As a result, in a case where the use of the fixing device 40 is continued, the film thickness of the lubricant 48 decreases with the decrease of the lubricant 48, and the slope of the Stribeck curve becomes negative (moves to the right in FIG. 8).

Moreover, in a case where the fixing device 40 continues to be used, as shown in FIGS. 10C and 10D, the film thickness of the lubricant 48 further decreases, the inner surface of the heating belt 42 partially contacts the inner surface of the ceramic heater 45, the fluid lubrication shifts to the mixed lubrication, and the coefficient of dynamic friction increases sharply. Thus, the stick-slip phenomenon occurs in which the contact portion of the heating belt 42 repeats slip while being slightly deformed, which causes the generation of the abnormal noise. The fixing device 40 is forced to be replaced in a case where the stick-slip phenomenon occurs and the abnormal noise is generated.

Thus, the related-art fixing device has already proposed that the surface roughness Ra of the inner surface of the belt is set to 0.3 μm to 1.5 μm in order to facilitate holding the lubricant between the heating belt and the sliding member (Paragraph [0043] of JP2020-154074A and the like).

However, only in a case where the surface roughness Ra of the inner surface of the belt is set to 0.3 μm to 1.5 μm in this way, the inner surface of the heating belt 42 brought into pressure contact with the ceramic heater 45 in the fixing nip portion N while the fixing device 40 is continuously used is gradually worn. As described above, it is not possible to effectively suppress the occurrence of the stick-slip phenomenon and the generation of the abnormal noise sooner or later, the fixing device 40 has reached the end of the lifespan thereof, and it is necessary to replace the entire fixing device 40 with a new one.

Thus, the fixing device 40 according to Exemplary Embodiment 1 is configured to include a roughened portion, which is provided adjacent to a downstream side in the movement direction of the heating belt 42 with respect to the pressure contact portion of the holding section and that is subjected to a roughening treatment for holding the abrasion powder 42b on the inner surface of the heating belt 42, in order to suppress the occurrence of poor lubrication due to the abrasion powder 42b generated by the wear of the inner surface of the heating belt 42 brought into pressure contact with the pressure roll 43 burying the concave portions on the inner surface of the heating belt 42.

More specifically, as shown in FIG. 6, the fixing device 40 according to Exemplary Embodiment 1 includes the second guide portion 464, which has a cross-sectional shape formed in a curved cross-sectional shape and is in contact with the inner surface of the heating belt 42, at a position adjacent to the downstream side of the fixing nip portion N of the holding member 46 in the rotational direction of the heating belt 42.

The second guide portion 464 of the holding member constitutes the roughened portion in which the surface roughness Ra of a surface 464a in contact with the inner surface of the heating belt 42 is set to be larger than the surface roughness Ra of the heating belt 42. The surface roughness Ra of the surface 464a of the second guide portion 464 is set to, for example, about 0.5 to 2.0 μm, preferably about 0.5 to 1.0 μm, and more preferably about 0.5 to 0.8 μm. The second guide portion 464 of the holding member 46 is provided adjacent to the downstream side in the movement direction of the heating belt 42 with respect to an outlet of the fixing nip portion N, and a pressure contact force does not act unlike the fixing nip portion N. For that reason, even though the surface roughness Ra of the surface 464a of the second guide portion 464 is set to be larger than the roughness of the heating belt 42, the wear of the inner surface of the heating belt 42 is not promoted, or even though the wear occurs, the fixing nip is extremely slight compared to the wear in the fixing nip portion N.

In a case where the holding member 46 is molded by injection molding or the like, the roughened portion 464a of the holding member 46 is formed simultaneously with the molding of the holding member 46 by performing a roughening treatment such that the surface roughness Ra of a portion corresponding to the roughened portion 464a of a mold for molding the holding member 46 becomes a value of the required surface roughness Ra. The roughened portion 464a of the holding member 46 is three-dimensionally provided in all directions including not only the movement direction of the heating belt 42 but also a direction intersecting the movement direction.

Operation of Fixing Device

In the fixing device according to Exemplary Embodiment 1, it is possible to suppress the occurrence of poor lubrication due to the abrasion powder generated by the wear of the inner surface of the belt brought into pressure contact with the rotating body burying the irregularities on the inner surface of the belt as follows.

That is, in the fixing device 40 according to Exemplary Embodiment 1, as shown in FIG. 2, during the fixing operation, the ceramic heater 45 is energized to heat the ceramic heater 45, and the pressure roll 43 is rotationally driven by a drive device (not shown) in the direction of arrow C. In this case, the heating belt 42 is brought into pressure contact with the pressure roll 43 and is rotated in a driven manner in a counterclockwise direction in the figure.

In the image forming apparatus 1, as shown in FIG. 1, in a case where the ceramic heater 45 of the fixing device 40 reaches the required fixing temperature, the recording paper 5 is fed from the paper feed device 50, and the toner image on the intermediate transfer belt 21 is secondarily transferred to the recording paper 5 at the secondary transfer position of the intermediate transfer device 20.

As shown in FIG. 2, the recording paper 5 to which the unfixed toner image T is transferred is transported to the fixing nip portion N where the heating belt 42 and the pressure roll 43 are in pressure contact with each other. In the recording paper 5 introduced into the fixing nip portion N, the toner image is heated and pressurized at the fixing nip portion and is subjected to a fixing treatment on the recording paper to be a permanent image.

In this case, in the fixing device 40, as shown in FIG. 6, the heating belt 42 held by the holding member 46 is brought into pressure contact with the pressure roll 43, and the heating belt 42 is rotated in a driven manner in the counterclockwise direction with the rotation of the pressure roll 43. The heating belt 42 is moved while supported on the surface of the ceramic heater 45 in the same state as a sliding bearing via the lubricant 48 applied to the inner surface thereof.

In a case where the fixing nip portion N, which is the pressure contact portion between the ceramic heater 45 and the heating belt 42, is microscopically viewed, as shown schematically in FIG. 7, the fluid lubrication can be viewed in which the layer of the lubricant 48 is interposed between the ceramic heater 45 and the heating belt 42.

Meanwhile, while the fixing device 40 is continuously used, as shown in FIG. 11, the convex portions on the inner surface of the heating belt 42 partially come into contact with the surface of the ceramic heater 45, and the inner surface of the heating belt 42 is worn to generate the abrasion powder 42b. The abrasion powder 42b formed as the inner surface of the heating belt 42 is worn moves in the movement direction of the heating belt 42 with the movement of the heating belt 42.

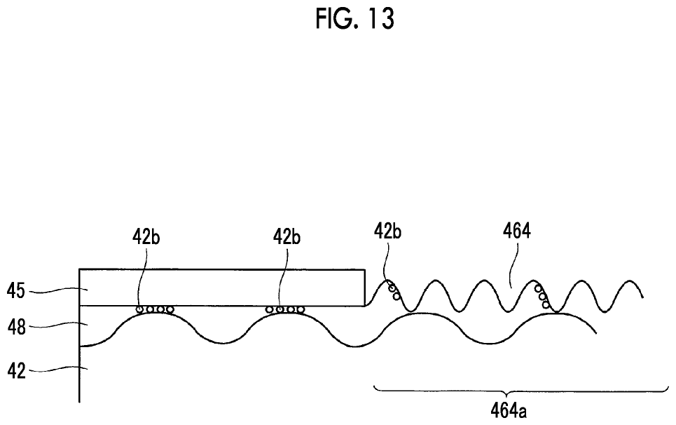

In the fixing device 40 according to Exemplary Embodiment 1, as shown in FIG. 6, the roughened portion 464a of the holding member 46 is provided adjacent to the downstream side of the fixing nip portion N in the movement direction of the heating belt 42. The surface roughness Ra of the roughened portion 464a of the holding member 46 is set to be larger than the surface roughness Ra of the inner surface of the heating belt 42. For that reason, as shown in FIG. 13, the abrasion powder 42b as the inner surface of the heating belt 42 is worn inside the fixing nip portion N moves to the downstream side with the movement of the heating belt 42 and comes into contact with the roughened portion 464a of the holding member 46, and the abrasion powder 42b is scraped from the inner surface of the heating belt 42 due to the surface roughness Ra of the roughened portion 464a.

The abrasion powder 42b on the inner surface of the heating belt 42 scraped by the roughened portion 464a of the holding member 46 stays at and held by the roughened portion 464a of the holding member 46.

Since the abrasion powder 42b on the inner surface of the heating belt 42 held by the roughened portion 464a of the holding member 46 is located on the downstream side of the fixing nip portion N in the movement direction of the heating belt 42, that is, on the downstream side with respect to the outlet of the fixing nip portion N, a pressing force caused by the pressure roll 43 does not act.

Therefore, the abrasion powder 42b on the inner surface of the heating belt 42 held by the roughened portion 464a of the holding member 46 is not filled in the roughened portion 464a by a pressing force acting on the heating belt 42 and is held in a state of having adhered to the side surfaces of the roughened portion 464a on the downstream side in the movement direction of the heating belt 42.

In this way, a phenomenon is suppressed in which the abrasion powder 42b held by the roughened portion 464a of the holding member 46 stays at and sticks to the concave portions on the inner surface of the heating belt 42, unlike the related-art fixing device 40 as shown in FIG. 11. Also, since the surface roughness Ra of the roughened portion 464a of the holding member 46 is larger than the surface roughness of the inner surface of the heating belt 42, many roughened portions 464a themselves are present in which the individual concave portions themselves are extremely small.

As a result, even though the abrasion powder 42b is held in the roughened portion 464a of the holding member 46, the individual concave portions of the roughened portion 464a are extremely small, and the effect of the abrasion powder 42b trapped by the individual concave portions of the roughened portion 464a absorbing the lubricant 48 is negligible.

Thus, while the fixing device 40 according to Exemplary Embodiment 1 is continuously used, even though the inner surface of the heating belt 42 is worn and the abrasion powder 42b is generated, a phenomenon is suppressed in which the abrasion powder 42b deposits in the concave portions on the inner surface of the heating belt 42 and absorbs the lubricant 48, the fluid lubrication of the heating belt 42 is hindered, and the poor lubrication occurs.

Therefore, the fixing device 40 according to Exemplary Embodiment 1 can maintain the fluid lubrication as shown in FIGS. 10A and 10B for a long period of time even though the fixing device 40 is continuously used, the generation of the abnormal noise associated with the stick-slip phenomenon resulting from poor lubrication can be suppressed, and longer lifespan of the fixing device 40 is possible.

In addition, in the above-described exemplary embodiment, a case where the endless belt is applied to the heating belt has been described. However, the present invention is not limited to this, and it is needless to say that the endless belt can be similarly applied to a pressure belt. Similarly, the rotating body is not limited to the pressure roll and may be the pressure belt.

Additionally, in the above-described exemplary embodiment, a case where the heating belt is applied has been described. However, the present invention is not limited to this, and it is needless to say that the heating member may be one made of a heating roll.

Additionally, although the present invention has been described with the electrophotographic image forming apparatus, the present invention is not limited to the electrophotographic image forming apparatus. For example, it is also possible to apply the present invention to an ink jet type image forming apparatus or the like in which an unfixed ink image is fixed on paper in contact with the paper transported while holding an image of an undried layer with ink (an unfixed ink image)

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a rotatable endless belt;
a holding section that is disposed inside the belt and holds a planar heat-generating element so as to bring the belt into pressure contact with a rotating body at a pressure contact portion; and
a roughened portion that is provided adjacent to a downstream side in a movement direction of the belt with respect to the pressure contact portion of the holding section and subjected to a roughening treatment for holding abrasion powder on an inner surface of the belt.

2. The fixing device according to claim 1,
wherein the roughened portion has a surface roughness larger than a surface roughness of the inner surface of the belt.

3. The fixing device according to claim 2,
wherein the roughened portion has a surface roughness Ra of 0.5 to 1.0 μm.

4. The fixing device according to claim 1,
wherein a surface roughness of the roughened portion is set by adjusting at least one of a surface roughness of a mold for molding the holding section with a synthetic resin, a pouring speed of the synthetic resin, or a molding temperature.

5. The fixing device according to claim 4,
wherein the surface roughness of the roughened portion is set by adjusting the surface roughness of the mold for molding the holding section with the synthetic resin.

6. The fixing device according to claim 1,
wherein the belt includes at least a base material layer, an adhesive layer, and a surface layer, and
a high thermal conductive filler having a low coefficient of friction is blended in the base material layer.

7. The fixing device according to claim 6,
wherein the high thermal conductive filler is made of carbon nanotubes.

8. An image forming apparatus comprising:
an image forming section that forms an image on a recording medium; and
a fixing section that fixes the image formed on the recording medium,
wherein the fixing device according to claim 1 is used as the fixing section.

9. An image forming apparatus comprising:
an image forming section that forms an image on a recording medium; and
a fixing section that fixes the image formed on the recording medium,
wherein the fixing device according to claim 2 is used as the fixing section.

10. An image forming apparatus comprising:
an image forming section that forms an image on a recording medium; and
a fixing section that fixes the image formed on the recording medium,
wherein the fixing device according to claim 3 is used as the fixing section.

11. An image forming apparatus comprising:
an image forming section that forms an image on a recording medium; and
a fixing section that fixes the image formed on the recording medium,
wherein the fixing device according to claim 4 is used as the fixing section.

12. An image forming apparatus comprising:
an image forming section that forms an image on a recording medium; and
a fixing section that fixes the image formed on the recording medium,
wherein the fixing device according to claim 5 is used as the fixing section.

13. An image forming apparatus comprising:
an image forming section that forms an image on a recording medium; and
a fixing section that fixes the image formed on the recording medium,
wherein the fixing device according to claim 6 is used as the fixing section.

14. An image forming apparatus comprising:
an image forming section that forms an image on a recording medium; and
a fixing section that fixes the image formed on the recording medium,
wherein the fixing device according to claim 7 is used as the fixing section.
